(19) United States
(12) Patent Application Publication
(10) Pub. No.: US 2010/0312641 A1
(43) Pub. Date: Dec. 9, 2010

(54) SYSTEM AND METHOD FOR PROVIDING COMPLEMENTARY ADVERTISING MEDIA CHANNELS

(75) Inventors: Alon Zaibert, Moshav Bnay Zion (IL); Amit Naor, Moshav Bnay Zion (IL)

Correspondence Address: FOLEY & LARDNER LLP, 777 EAST WISCONSIN AVENUE, MILWAUKEE, WI, 53202-5306, US

(73) Assignee: TRUVLE TECHNOLOGIES LTD., Tel Aviv (IL)

(21) Appl. No.: 12/808,934

(22) PCT Filed: Dec. 18, 2008
(86) PCT No.: PCT/IB08/03834

§ 371 Date: Jun. 17, 2010

Related U.S. Application Data
(60) Provisional application No. 61/016,435, filed on Dec. 21, 2007.

(51) Int. Cl. G06Q 30/00

(52) U.S. Cl. 705/14.51; 705/14.72

(57) ABSTRACT

Systems and methods are provided for modifying e-tickets/itineraries with advertising content before being forwarded to end-user customers. These modified e-tickets/itineraries may also provide a link to a reservation/service-related home page that contains additional advertisement information and provides the end-user customer with the ability to further tailor his/her reservation and services. Additionally, systems and methods are provided to allow advertising customers to bid on or purchase advertising space based on flat, qualitative gradual, and/or specific targeting of potential end-user customers using data gathered during a reservation and/or purchase service session. Furthermore, the bidding process can involve correlative gradual pricing thus enabling advertising customers to strategically and efficient plan and manage a marketing campaign.

### FIELD OF THE INVENTION

The present invention relates generally to information collection and distribution services. More particularly, the present invention relates to utilizing complimentary media channels to provide intelligent and integrated advertising, as well as promotions and other relevant information for e-ticketing services.

### BACKGROUND OF THE INVENTION

The reservations and purchase services marketplace encompasses a global arena including, e.g., reservations and purchase agents, end-user customers, and service providers such as hotels, airlines, and car rental agencies. These various entities interact within the reservations and purchase services marketplace to provide, request, and purchase or rent, for example, airline tickets, hotel rooms, and rental cars. Traditionally, these services require that an end-user customer request and make a reservation for a particular service, where tickets are utilized as a form of verification for that reservation, thus allowing the end-user customer to utilize the service at the appropriate or desired time.

A reservations and purchase agency (RPA) can refer to a business that provides reservations and purchase-related products and/or services, including but not limited to, e.g., package vacation tours to end-user customers. Such reservations can be made on behalf of reservations and purchase suppliers (RPSs), such as the aforementioned airlines, hotels, car rental agencies, as well as tour companies, cruise lines, and the like. For example, an end-user customer can utilize a particular RPA to create a reservation, while an RPS can provide an actual ticket. Alternatively, an RPA travel agents can themselves issue tickets on behalf of a service provider.

Alternatively still, and due to the prevalence of the Internet and web-based businesses, a ticket such as that described above, can be generated and presented in an electronic ticket format, conventionally referred to as an “e-ticket” or itinerary. Hence, an end-user customer may visit a web site of an RPA using the Internet to make a reservation arrangement. Once the reservation or purchase is made, the end-user customer is provided with an e-ticket or itinerary for the reserved or purchased goods or services. In contrast to a paper ticket, the e-ticket/itinerary can exist as a digital record in a server or database belonging to the RPA or RPS. The end-user customer may then print out one or more copies of their e-ticket/itinerary for presentation or may simply provide some identifying information to, e.g., an airline check-in counter, that allows the e-ticket/itinerary for that end-user customer to be retrieved. The e-ticket/itinerary may contain various types of information including, but not limited to a reservation number, an e-ticket/itinerary number, a confirmation number, one or more dates for which the reservation is valid, the end-user customer's relevant information, etc.

Conventionally, when a RPA, such as a travel agent desires to create a reservation for an end-user customer, the travel agent will electronically access a Global Distribution System (GDS) or other appropriate system, such as a back office system. A GDS (or any other similar system, e.g., a hotel-only booking system available to travel agents) refers to a globalized computer reservation system that utilizes reservation databases of service providers in a plurality of different countries. Commonly known GDSs include AMADEUS, GALILEO, Worldspan, and SABRE. Service providers such as airlines feed one or more GDSs with data relating to their particular service(s). In the case of airlines, for example, information such as flight schedules and seating availability on flights is provided to the GDS. The GDS is then used by a travel agent to retrieve relevant flight information and conduct transactions related to the creation of reservations. It should be noted that other types of reservations can be reserved through the GDS, e.g., hotel reservations, cruises, rail, etc. Therefore, the GDS can act as an intermediary between RPSs and RPAs. The GDS can also take on the responsibility of creating e-tickets/itineraries for RPSs.

FIG. 1 is a diagram of a prior art reservations and purchase services network showing the interconnection of a GDS, a RPA, and a RPS. An RPS 32, which can include providers such as airline companies 34, bus line companies 36, car rental companies 38, rail way companies 40 and hotel companies, supply GDS 42 with data, e.g., flight data, bus schedules, and available cars for rent. An RPA 44 receives a reservation or purchase request from an end-user customer. Information regarding the reservation or purchase request from the end-user customer may be sent via a communications network 46, such as the Internet. During and at the conclusion of a reservation-creation session, the GDS 42 generates notifications which can take the form of a text file, an extensible markup language (XML) file, and the like, which are associated with the reservation request of the end-user customer. A notification can include, e.g., personal details about the end-user customer, details about a flight on which the end-user customer wishes to reserve a seat. Lastly, the travel agent receives the notification/e-ticket/itinerary from the GDS 42, which can then be sent to the end-user customer in, e.g., an email.

Although in certain cases, advertisement content or links to advertisements can be included in the notifications sent from the GDS 42 to the RPA 44, travel agents do not traditionally modify the received e-ticket/itinerary to include such advertisement content, nor is the e-ticket/itinerary personalized with, e.g., branding of the RPA 44. At best, an email including the e-ticket can contain a link to such advertisement content. Additionally, the RPA 44 does not conventionally receive any type of shared revenue generated by the advertisement content or advertisement links provided by the GDS 42.

### SUMMARY OF THE INVENTION

In accordance with one aspect of the present invention, a system and method of advertising over complementary media channels is provided. A marketing platform can be installed at a RPA computer, server, or network that pulls notifications/e-tickets/itineraries from one or more GDSs/booking systems/back office systems. The data contained in these notifications/e-tickets relating to end-user customers reservation and purchase service experience is at least parsed, filtered, and/or organized so that advertising content can be tailored to the particular end-user customers. The notifications/e-tickets are then modified with the tailored advertising content. Additionally, home pages containing at least the same and/or additional advertising content can be provided to the end-user customers in addition to the modified notifications/e-tickets.

In accordance with another aspect of the present invention, a campaign and bidding management tool is provided to advertising customers. Advertising customers can bid on or purchase advertising space based on flat, qualitative gradual, and/or specific targeting of potential end-user customers using at least the data gathered from the GDS/booking system/back office system notifications/e-tickets/itineraries. Furthermore, the bidding and/or purchase process can involve correlative gradual pricing thus enabling advertisers to strategically and efficiently plan and manage a marketing campaign.

Although certain features and advantages are described herein, it will be appreciated that the teachings below may be used to implement systems and methods which do not necessarily have any of these features and advantages, but which have other features and advantages.

### BRIEF DESCRIPTION OF THE DRAWINGS

FIG. 1 is a block diagram of a prior art reservations and purchase services network;

FIG. 2 is a block diagram of a reservations and purchase services network in accordance with various embodiments of the present invention;

FIGS. 3A and 3B are representations of two complementary media channels utilized in accordance with various embodiments of the present invention;

FIG. 4 is a flow chart illustrating processes performed in accordance with various embodiments of the present invention to provide the two complementary media channels of FIGS. 3A and 3B;

FIG. 5 is a diagram illustrating the end-user customer and campaign bidding management aspects of various embodiments of the present invention;

FIG. 6 is an exemplary representation of a campaign bidding module in accordance with various embodiments of the present invention; and

FIG. 7 is a representation of a bidding/purchase application in accordance with various embodiments of the present invention.

### DETAILED DESCRIPTION OF THE PREFERRED EMBODIMENTS

Various embodiments of the present invention include systems and methods of integrating intelligent advertising into e-tickets/itineraries thus providing added value for end-user customers. Additionally, various embodiments of the present invention allow advertisers to better target potential end-user customers while providing shared revenue to RPAs. According to one aspect of the present invention, e-tickets/itineraries may be modified with various types of advertising information before being forwarded to end-user customers. These modified e-tickets/itineraries may also provide a link to a reservation/service-related home page that contains additional advertisement information and provides the end-user customer with the ability to further tailor his/her reservation and services.

In accordance with another aspect of the present invention, a campaign and bidding management tool is provided to advertising customers. This campaign and bidding management tool allows the advertising customers to bid on advertising space based on flat, qualitative gradual, and/or specific targeting of potential end-user customers using data gathered during a reservation and/or purchase service session. Furthermore, the bidding process can involve correlative gradual pricing thus enabling the advertising customers to strategically and efficiently plan and manage a marketing campaign.

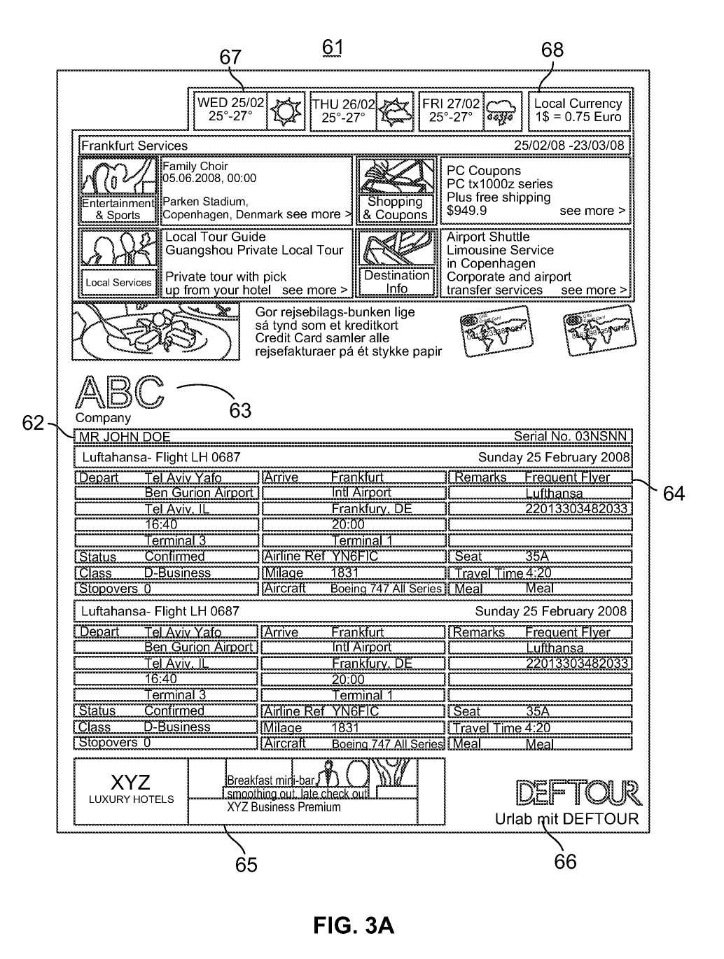

FIG. 2 is a block diagram illustrating a reservations and purchase services network in accordance with various embodiments of the present invention. As described above, RPSs 32 can be representative of businesses or service providers, such as airline companies 34, bus line companies 36, car rental agencies 38, rail way companies 40, and hotels. It should be noted that various embodiments of the present invention are not limited to interactions with only those service providers mentioned above. The description of various embodiments herein are merely exemplary, and may include more or less service providers that accept reservations and utilize some form of e-ticketing/itineraries. The RPSs 32 supply notifications to a GDS 42. As described above, the GDS 42 can also be implemented in/embodied as, e.g., a booking system or engine, back office system, etc. These notifications are text or other types of electronic files that are associated with reservations and purchases, such as flights, bus schedules, and available cars for rent. An RPA 44 receives a reservation or purchase request from a customer. Information regarding the reservation or purchase request from the end-user customer may be sent via a communications network 46, such as the Internet (in various ways including, but not limited to XML, scrolling/crolling, etc.) The GDS 42 interacts with the RPA 44 to establish a reservation or a purchase for an end-user customer. Also as described above, during and at the end of a reservation or purchase session, the GDS 42 generates notifications that are transmitted to the RPA 44, relating to the reservation or purchase request of the end-user customer. It should further be noted that although only a single GDS, and a single RPA are shown in FIG. 2, various embodiments of the present invention can be implemented in networks having multiple GDSs and RPAs.

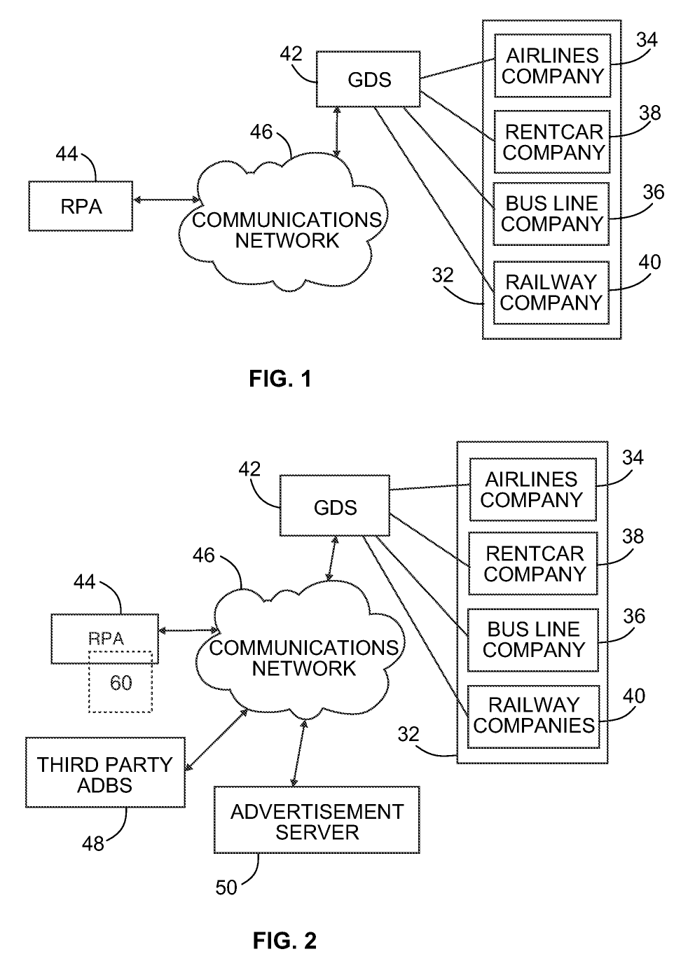

Unlike the prior art reservations and purchase services network of FIG. 1, various embodiments of the present invention utilize an additional marketing platform 60 that can be operatively implemented on or connected to the RPA 44. The platform 60 can comprise one or more applications as will be described below, in addition to one or more file servers and/or databases. One aspect of the platform 60 is a data capturing application for capturing data transmitted to and from the GDS/booking system/back office system 42. An exemplary embodiment of this data capturing application can be implemented in the form of a “sniffer” or through some other type of electronic monitor(s) or feed(s) that utilize, e.g., XML. A sniffer is a utility program that can be installed, for example, at an end-point computer (e.g., travel agent personal computer), server, or local network of the RPA 44. The sniffer can be also configured to continuously operate by capturing data transferred between the GDS 42 and the RPA 44 over the same communications network 46. That is, the sniffer can “listen” to transmissions to and from the GDS 42. If the sniffer recognizes relevant notifications, the sniffer collects some or all of the data from a notification and provides this data to a third party application and data base server (ADBS) 48.

Relevant notifications are recognized by the sniffer since the GDS 42 uniquely identifies each notification. The data contained in each recognized notification can include, but is not limited to: an end-user customer's trip information, such as the dates of the trip; the destination(s) of the trip; seating class (e.g., economy, business class, first-class); gender of the end-user customer; and the type of food requested by the end-user customer. The sniffer can parse and filter the notifications to gather and organize this data which can subsequently be stored in the file server(s) and/or database(s) of the platform 60. Organization of this gathered data can comprise matching pieces of data that are associated with the same unique identification provided by the GDS 42. Additionally, and/or alternatively, trends and statistical data can be derived from the gathered data by, e.g., determining that certain data, such as the rental of a particular type of car from a car rental agency occurs more frequently with male end-user customers. Various algorithms and/or logical systems and methods can be utilized for the parsing, filtering, and/or organization of the gathered data. It should be noted, however, that private details regarding the end-user customer such as credit card information is an example of data that need not be collected from the notifications, e.g., for privacy reasons.

The data gathered by the sniffer can then be provided to the ADBS 48, which in turn can send the data to an advertisement server 50, where advertisements/advertisement content can be generated. After the advertisement content is generated at the advertisement server 50, the advertisement content may be sent back to the ADBS 48 for storage and access when needed. Alternatively, it is possible to send the data directly to the advertisement server 50 for the generation of the advertisement content. The advertisement server 50 utilizes the data for generating advertisements for additional products and/or services that may be relevant to the end-user customer based upon the reservation(s) requested by and created for the end-user customer. For example, advertisements related to road map services tailored to an end-user customer's destination(s) can be generated. Another example of possible advertisements can include but are not limited to, concerts that are occurring during the time and destination(s) of the end-user customer's travel, coupons for venues near or at that destination(s), additional reservations and/or tickets for sporting events, and advertisement banners for hotels at or near the destination(s). It should be noted that the ADBS 48 can be considered to be a part of or operatively connected to the platform 60. As will be described in greater detail below, various embodiments of the present invention allow the RPA 44 to, e.g., rotate and/or customize banner space on one or both of the complimentary media channels described herein for businesses that seeking to advertise the products and/or services.

Regardless of where or how the advertisement content is generated or received, e-tickets generated by the RPA 44 or received at the RPA 44 from the GDS 42 can be modified to include this advertisement content. That is, the advertisement content can be directly integrated into the e-ticket itself and once the e-ticket has been modified with this advertisement content, the e-ticket can be transmitted to an end-user consumer. Modification of an e-ticket can be performed automatically by the platform 60 without any further interaction by the RPA 44 or a travel agent of the RPA 44. However, the platform 60 allows further customization of the e-ticket if desired. That is, the RPA 44 or a travel agent thereof can utilize a modification program of the platform 60 to, e.g., brand the e-ticket with a logo of the RPA 44 or further tailor the modified e-ticket to the end-user customer's or RPA's needs or desires.

E-tickets/itineraries can be transmitted to end-user customers via email, short message service (SMS), multimedia messaging service (MMS). It should be noted that these modes of transmission are merely exemplary and the various embodiments of the present invention are not limited to solely these methods of transmission. Therefore, the end-user consumer becomes aware of the products and/or services advertised in the modified e-ticket/itinerary without having to be redirected to a separate URL or Web-based link. Instead, the end-user customer can, upon viewing an emailed e-ticket/itinerary or printing the e-ticket/itinerary, immediately become aware or take advantage of the additional products and services advertised to enhance his/her reservation and service purchase experience.

After or substantially at the same time the modified e-ticket/itinerary has been created, a Web-based home page can also be created for the end-user customer that is also based on the data gathered from the sniffer/monitor/feed of platform 60 and the advertisement content generated by the ADBS 48 and/or advertisement server 50. This home page can present even more advertisement/promotional content, such as clickable banners, a greater range or additional products and services that are available to the end-user customer, a more detailed travel/activity itinerary, currency exchange data for foreign travelers, separate pages or links for each destination with additional advertisement content tailored to each destination, etc. If the end-user customer has a reservations and purchase services history with a particular RPA, the home page can also be populated with data regarding that end-user customer's past travel history, including but not limited to destinations traveled to, hotels stayed at, etc. In addition, personal information (not shown) for the end-user customer can be stored in his/her home page. This personal information can be altered and updated as desired by the end-user customer. It should be noted that such interactions between the end-user customer and his/her respective home page can also be utilized to tailor advertisements that are presented in a similar manner as that already described above.

Presenting at least two complementary media channels, both of which can be utilized for advertising again, exposes end-user customers to more opportunities with which to enhance their reservations and purchase service experience. Additionally, RPAs and RPSs are afforded more opportunities to present their services and/or products to potential customers. Moreover, the RPSs and RPAs are able to generate income from those potential customers that respond to advertisements by purchasing additional products and services, as well from additional shared revenue from the marketing platform 60 provider.

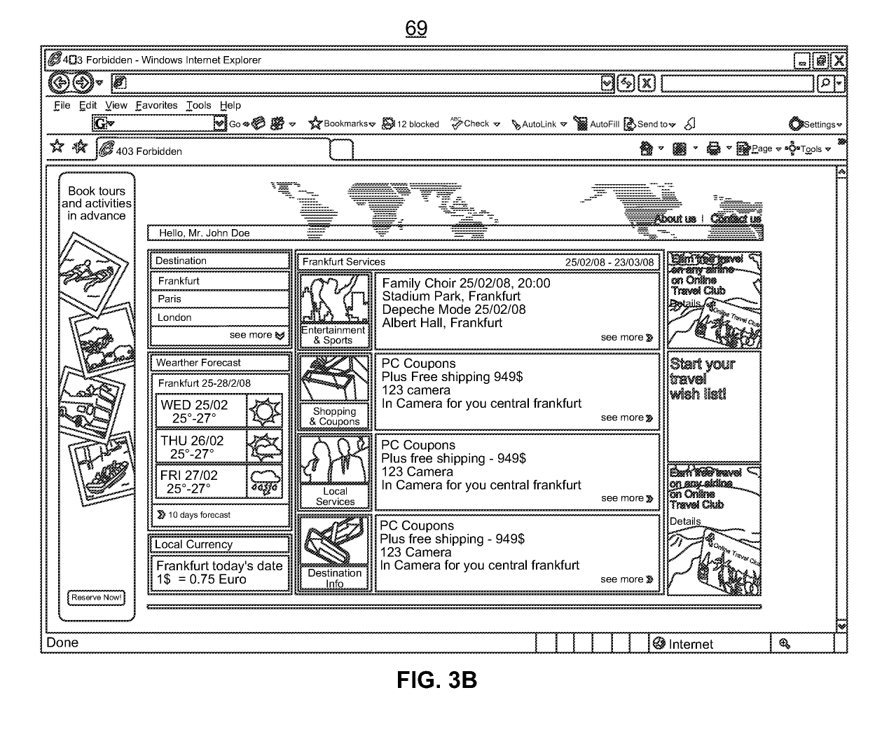

FIGS. 3A and 3B are representations of two complementary media channels utilized in accordance with various embodiments of the present invention. Modified e-ticket/itinerary 61 includes an end-user customer's personal details 62, such as for example, his/her name, customer ID number, and nationality. The modified e-ticket/itinerary 61 further includes a logo of the travel agency 63 serving the end-user customer and the serving GDS/booking system/back office system 66. If the modified e-ticket/itinerary is for a flight reservation, flight information such as flight destination and charges are displayed in area 64. Advertisements, such as a hotel banner 65 represent advertisements received from the advertisement server 50. The modified e-ticket/itinerary may further include weather information 67 and currency information 68 in addition to other advertisements related to, e.g., concerts, coupons, and the like. As described previously, the advertisements may be specifically tailored to the end-user customer. That is, the advertisements are generated with reference to the end-user customer's travel habits, flight destination and origin, travel dates, seating class, gender, age, meal type, etc.

Moreover, such parameters can be utilized in a predictive manner for advertisement generation. For example, an end-user customer that has reserved a first class seat on airline receives a modified e-ticket/itinerary containing advertisements about limousine services, premium hotels and restaurants, etc. A teenage traveler on the other hand may receive advertisements associated with party venues, rock concerts, and the like which are held in the country in which he/she flies to during the time of travel.

The home page 69 that is created for the end-user customer, as described above, can contain the same advertisement content contained in the modified e-ticket/itinerary 61 and/or additional advertisement and relevant information. For example, the home page 69 can divide relevant travel data and advertisements by each destination that the end-user customer will travel to. It should be noted that an end-user customer can be notified of the home page created for him/her via, e.g., a hyperlink that is provided in the e-ticket/itinerary, or through some other type of alert or notification. Moreover, the home page can be configured so that each time the end-user customer chooses a certain destination the rest of the relevant data and advertisements are updated without refreshing the page. For example, by the time the home page 69 has been created, all of the customer-related data has been received, compiled, and processed so that any possible advertisement content relating to any possible destination in the customer's trip can be determined and presented immediately. That is, no additional contact between the RPA, ADBS, and advertisement server is required after issuance of an e-ticket/itinerary. It should be noted that the home page 69 can be hosted on servers associated with and/or integrated into the platform 60.

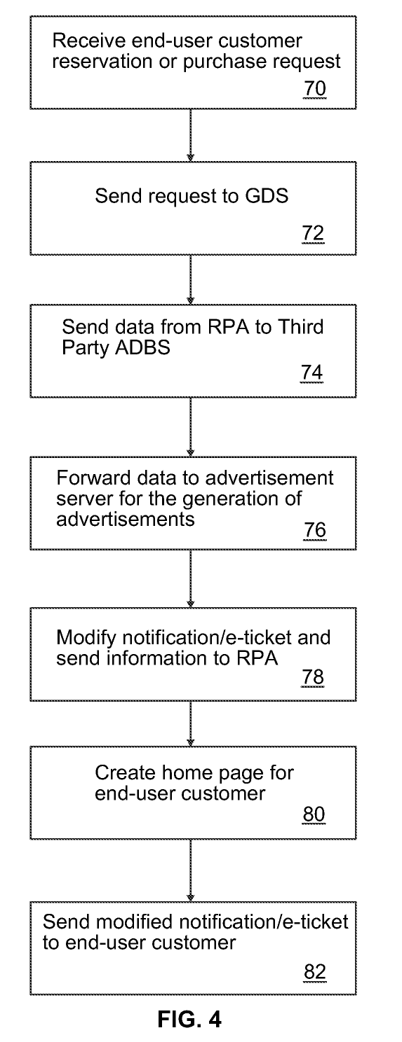

An exemplary method of providing two complementary media channels for advertising is described in the flow chart illustrated in FIG. 4. At step 70, an RPA receives a customer reservation or purchase request. At step 72, the RPA sends this request to the GDS/booking system/back office system and the GDS/booking system/back office system begins a reservation/purchase session with the RPA. At step 74, a part or all of the data in one or more notifications transferred between the GDS/booking system/back office system and the RPA is sent to a third party ADBS. At step 76, the ADBS can forward the data to an advertisement server, where the generation of the advertisements is performed. It should be noted however, that as will be described below, the generation of advertisements can be based upon the data forwarded thereto by the ADBS as well as upon, e.g., statistical data received from or determined for advertising customers. It should also be noted that it is possible to offer substantially immediate on-line advertising for generating advertisements “on the spot” from advertising customers, where the advertisements can be generated and stored directly at the ADBS . At step 78, the notification (e.g., e-ticket/itinerary) is modified or created to accommodate the received or generated advertisements and sent to the RPA. At step 80, a private home page for the customer is generated. At step 82 the modified notification/e-ticket/itinerary is sent to the end-user customer through a communications conduit such as e-mail, SMS, MMS or as a printed paper hardcopy.

Various embodiments of the present invention have been described above from an end-user customer and RPA/RPS perspective. According to another aspect of the present invention, various embodiments provide a campaign and bidding management tool. That is, advertisers can buy or bid for advertising space on a modified e-ticket/itinerary, end-user customer home page, or other notifications related to reservation and purchase that are sent to the end-user customer. For example during a holiday season, a local souvenir shop or a company that offers, e.g., sky packages, can buy banner space in the modified e-ticket to advertise.

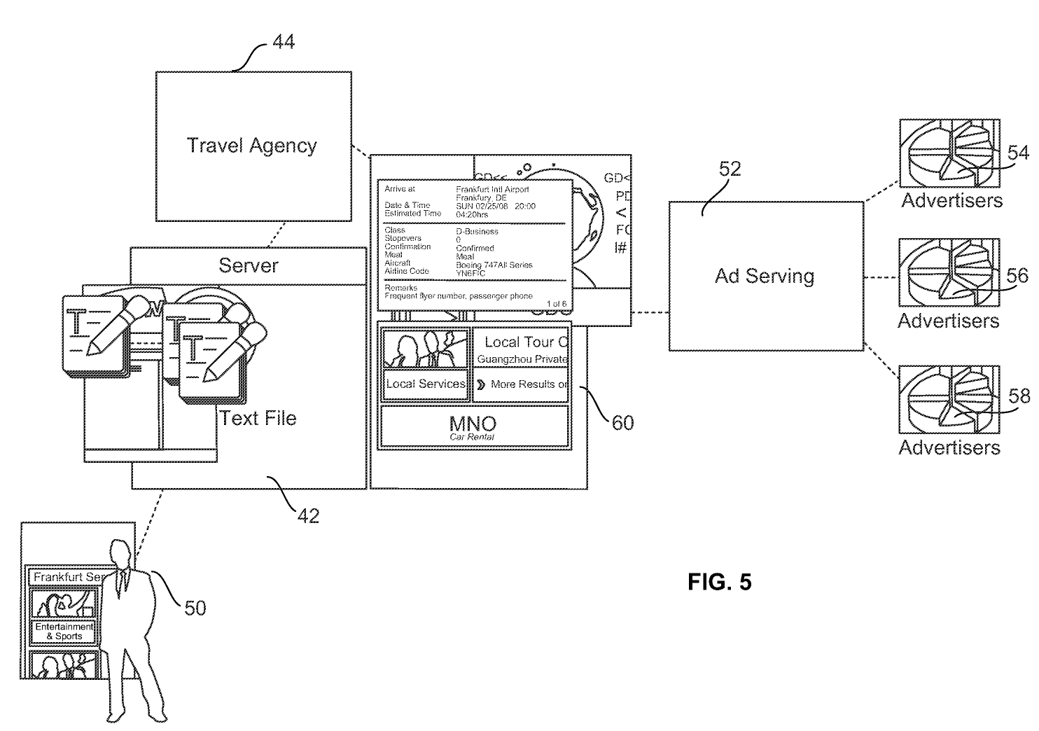

FIG. 5 is a diagram illustrating the interaction between the platform 60 and the RPA 44, the GDS 42, and the end-user customer 50, and the interaction between the platform 60 and an ad serving/campaign and bidding management application 52 and advertising customers 54, 56, and 58. While an end-user customer 50 can receive a modified e-ticket and home page related to his/her reservations and service purchases as described above over a communications network such as the Internet, advertising customers 54, 56, and 58 can also connect to the campaign and bidding management tool 52 over the same or a similar communications network.

Various embodiments of the present invention, through the campaign and bidding management tool 52, can expose advertising customers 54, 56, and 58 to unique, characterized, segmented, recognized, available, and/or captive end-user customers. Different pricing schemes can be utilized in order to meet the varying needs and desires of advertising customers. For example, a banner or advertising space on a modified e-ticket/itinerary can be set to a first price or price range. Banner or advertising space on an end-user customer home page can be set to a second price or price range.

Moreover, advertising customers can use the campaign and bidding management tool 52 directly, as described above, or indirectly through affiliate partnerships that may have an existing relationship with the platform 60 provider. That is, an online ticketing service, such as Expedia.com or Hotwire.com may already have purchased or leased advertising space on one or both of modified e-tickets and end-user customer home pages. A third party advertising customer may then be able to advertise on the modified e-tickets/itineraries and/or end-user customer home pages through the advertising space of Expedia.com or Hotwire.com. It should be noted that affiliate partners need not be limited to online ticketing/itinerary services, but can also include, e.g., peripheral websites, search engines, and the like. It should also be noted that although references are made to a “bidding” type tool, purchasing for a set price can also be effectuated in accordance with various embodiments of the present invention.

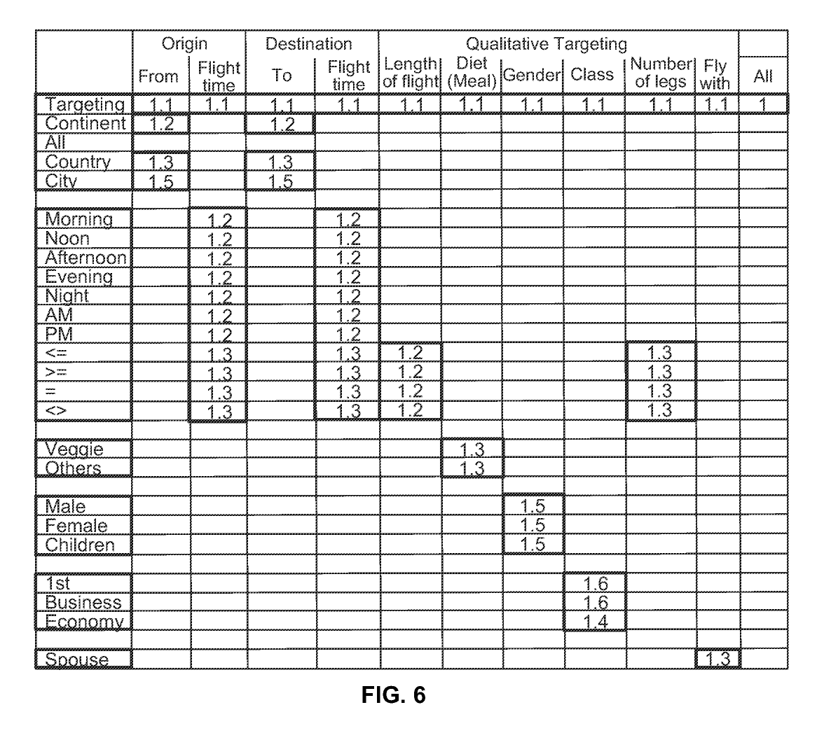

FIG. 6 illustrates a gradual pricing matrix that is utilized by the campaign and bidding management tool 52 in accordance with various embodiments of the present invention. A plurality of varying parameters related to end-user customers' travel statistics, histories, tendencies, etc. can be organized in an matrix that allows advertising customers to specifically direct their marketing and advertising efforts towards specific groups of end-user customers. For example, advertising customers can simply target a broad audience of end-user customers by specifying that their desired audience comprises those travelers that have a particular destination associated with their reservation. It should be noted that the various parameters shown in FIG. 6 are not meant to be limiting, but rather an example of possible parameters that can be determined from the above-described statistics, histories, tendencies, etc. which have already been stored by the platform 60. Moreover, it is not necessary to utilize a matrix, as other methods of organizing and providing such data can be utilized in accordance with various embodiments of the present invention.

Alternatively, advertising customers can narrow their desired audience by specifying additional parameters associated with particular end-user customers. For example, instead of targeting all travelers traveling to a particular destination, advertising customers can specify that they would like to advertise to travelers who specify a particular type of meal in addition to their specified travel destination. More or less parameters can be combined to arrive at different target audiences. Furthermore, the pricing associated with advertising to the various combinations of parameters can be graduated. That is, a higher price/price range (for purchase or bidding, respectively) can be set for advertisements that are to be sent to a narrow target audience, while a lower price can be set for advertisements that are to be sent to a broader target audience, and vice-versa. Further still, pricing can additionally be set on a per-modified e-ticket basis, e.g., correlative gradual pricing. With these varied pricing and targeting schemes provided by various embodiments of the present invention, advertising customers are provided with intelligent advertising options that allow for efficient and strategic marketing campaigns.

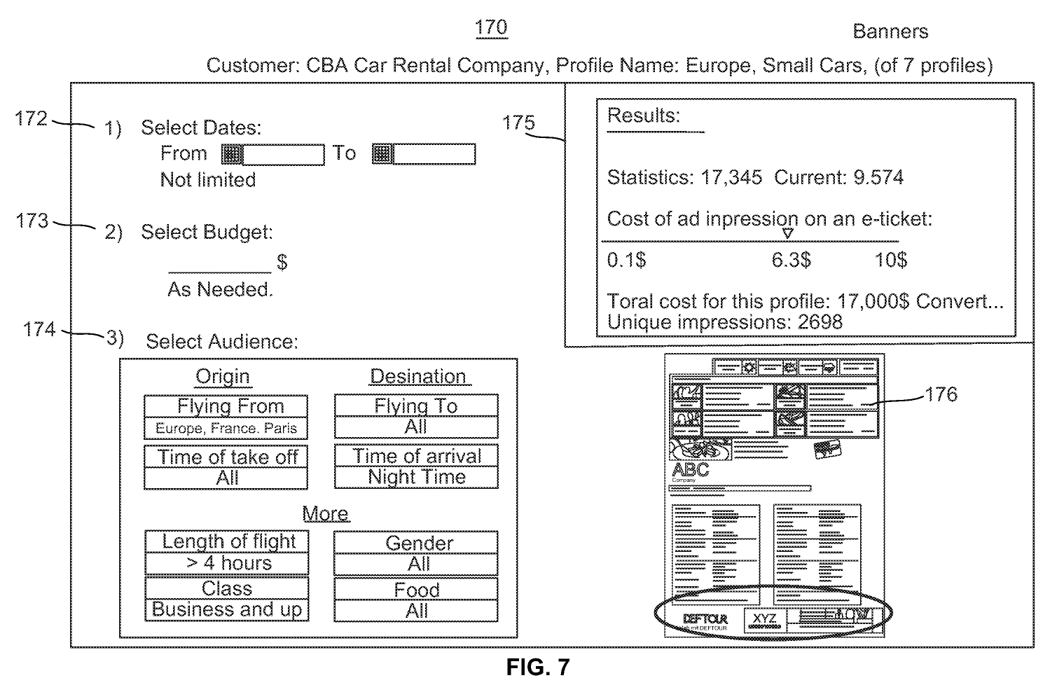

FIG. 7 is a representation of an exemplary bidding/purchase screen that can be provided as a front-end for the campaign and bidding management tool in accordance with various embodiments of the present invention. An advertising customer can connect to the campaign and bidding management tool to specify a desired target audience of end-user customers. At 172, the advertising customer can specify a range of dates through which it desires its advertisements to be included in modified e-tickets and/or end-user customer home pages. At 173, the advertising customer can select a budget that can be spent on the desired advertising. At 174, the advertising customer can specify the desired target audience by specifying particular parameters related to the target audience. The gradual pricing matrix described above is utilized as the back-end to this exemplary bidding/purchase screen. The results of the choices made at 172, 173, and 174 are then shown to the advertising customer at 175. The total number of possible statistics or parameters can be shown as well as the current number of statistics or parameters chosen by the advertising customer. Additionally, the price of advertising, e.g., on a modified e-ticket/itinerary is shown on a sliding graduated scale. More or less result information can be shown to each respective advertising customer. At 176, a preview of a modified e-ticket/itinerary can be shown to the advertising customer with their desired advertisement content included therein.

It will be further appreciated that system and method described herein may perform fewer or additional functions as compared to those described herein. For example, an entity (e.g., a RPA or marketing platform) that performs and/or utilizes only some of the above-mentioned processes may use a computer system that contains only a subset of the functions described herein. Additionally, one or more of the systems or functions described above may be variously combined in alternative configurations.

The foregoing description of embodiments has been presented for purposes of illustration and description. It is not intended to be exhaustive or to be limited to the precise forms disclosed, and modifications and variations are possible in light of the above teachings or may be acquired from practice of the invention. The embodiments were chosen and described in order to explain the principals of the invention and its practical application to enable one skilled in the art to utilize the invention in various embodiments and with various modifications as are suited to the particular use contemplated. It is intended that the scope of the invention be defined by the claims appended hereto and their equivalents.

What is claimed is:

1. A method for providing advertising, comprising:
capturing customer data associated with an electronic ticket;
at least one of generating and requesting advertisement content related to the customer data;
modifying the electronic ticket to include the at least one of the generated and requested advertisement content; and
creating a web page comprising at least the at least one of the generated and request advertisement content.

2. The method of claim 1, wherein the customer data comprises at least some data included within a notification transmitted from a global reservation system.

3. The method of claim 1, further comprising at least one of parsing, filtering, and organizing the customer data to determine relevant reservation and ticketing parameters.

4. The method of claim 1, further comprising transmitting the customer data to a third party application and data base server, wherein the third party application and data base server forwards the customer data an advertisement server.

5. The method of claim 4, further comprising generating the advertisement content at the advertisement server and transmitting the advertisement content back to the third party application and data base server for storage.

6. The method of claim 5, further comprising requesting the advertisement content from the third part application and data base server for the modifying of the electronic ticket, wherein the modified electronic ticket is sent to an end-user customer.

7. The method of claim 1, further comprising storing the customer data.

8. The method of claim 7, further comprising allowing advertisement customers to submit a bid for advertising space within at least one of the modified electronic ticket and the web page, wherein the bid is based upon a target audience derived from the stored customer data.

9. The method of claim 8, wherein a bid amount is commensurate with a graduated price range based upon at least one of a narrowing and broadening of the target audience.

10. The method of claim 1, wherein the web page includes additional advertisement content related to the customer data.

11. A computer program product, comprising computer code configured to perform the processes of claim 1.

12. A platform for providing advertising, comprising:
a sniffer configured to receive and recognize customer data within a notification, wherein the sniffer is further configured to at least one of parse, filter, and organize the customer data for tailoring advertisement content;
a modifier configured to modify the notification to include the tailored advertisement content; and
a web page creator configured to create a web page comprising at least information contained in the modified notification and the tailored advertisement content.
